(19) United States
(12) Patent Application Publication
(10) Pub. No.: US 2010/0289602 A1
(43) Pub. Date: Nov. 18, 2010

(54) WAVEGUIDE TRANSITION ARRANGEMENT

(76) Inventors: Per Ligander, Goteborg (SE); Marcus Karl Hasselblad, Molndal (SE)

Correspondence Address: ERICSSON INC., 6300 LEGACY DRIVE, M/S EVR 1-C-11, PLANO, TX, 75024, US

(21) Appl. No.: 12/810,053

(22) PCT Filed: Mar. 27, 2008
(86) PCT No.: PCT/SE2008/000231

§ 371 Date: Jun. 22, 2010

(30) Foreign Application Priority Data
Dec. 20, 2007 (SE) PCTSE0701152

(51) Int. Cl. H01P 1/04

(52) U.S. Cl. 333/254

(57) ABSTRACT

The present invention relates to a transition arrangement comprising a first surface-mountable waveguide part (4), a second surface-mountable waveguide part (5) and a dielectric carrier material (1) with a metalization (M) provided on a first main side (2). Each waveguide part (4, 5) comprises a first wall (7, 10), a second wall (8, 11) and a third wall (9, 12), which second and third walls (8, 9; 11, 12) are arranged to contact a part of the metalization (M), where the surface-mountable waveguide parts (4, 5) are arranged to be mounted on the dielectric carrier material (1) in such a way that the surface-mountable waveguide parts (4, 5) comprise ends (4a, 5a) which are positioned to face each other. The transition arrangement further comprises an electrically conducting sealing frame (17) that is arranged to be mounted over the ends (4a, 5a), covering them, where the frame (17) has a first wall (18), a second wall (19) and a third wall (20), where the second and third walls (19, 20) are arranged to contact a part of the metalization (M).

### TECHNICAL FIELD

The present invention relates to a transition arrangement comprising a first surface-mountable waveguide part, a second surface-mountable waveguide part and a dielectric carrier material with a metalization provided on a first main side, the first waveguide part comprising a first wall, a second wall and a third wall, which second and third walls are arranged to contact a part of the metalization, all the walls together essentially forming a U-shape, the second waveguide part comprising a first wall, a second wall and a third wall, which second and third walls are arranged to contact a part of the metalization, all the walls together essentially forming a U-shape, where the surface-mountable waveguide parts are arranged to be mounted on the parts of the metalization in such a way that the surface-mountable waveguide parts comprise ends which are positioned to face each other.

### BACKGROUND

When designing microwave circuits, transmission lines and waveguides are commonly used. A transmission line is normally formed on a dielectric carrier material. Due to losses in the dielectric carrier material, it is sometimes not possible to use any transmission lines. When there for example is a diplexer in the layout, the diplexer may have to be realized in waveguide technology. Waveguides are normally filled with air or other low-loss materials.

Waveguide diplexers used today are large mechanical components screwed into a mechanical cabinet and connected to different parts such as for example an antenna via some type of waveguide flange. It is desirable to mount such a diplexer structure on a dielectric carrier material, such that it forms a surface-mounted waveguide structure.

Such a surface-mounted waveguide is normally made having three walls and one open side. Metalization is then provided on the side of the dielectric carrier material facing the waveguide, where the metalization serves as the remaining wall of the waveguide, thus closing the waveguide structure when the waveguide is fitted to the dielectric carrier material.

An example of surface-mountable waveguides is disclosed in the paper “Surface-mountable metalized plastic waveguide filter suitable for high volume production” by Thomas J Müller, Wilfried Grabherr, and Bernd Adelseck, 33^{rd} European Microwave Conference, Munich 2003. Here, a surface-mountable waveguide is arranged to be mounted on a so-called footprint on a circuit board. A microstrip conductor to waveguide transition is disclosed, where the end of the microstrip conductor acts as a probe for feeding the waveguide's opening.

But in order to achieve surface mounting larger mechanical components such as a triplexer may result in problems with mechanical stress problems due to different coefficients of thermal expansion, CTE, of the materials involved. Furthermore, such a large surface-mounted structure as a triplexer is too large to handle in an automated production line.

One way to solve this problem is to split up the diplexer into a number of smaller parts. These parts have to be sufficiently connected to each other in order to present a proper electrical function. This problem is apparent for all large surface-mounted waveguide structures.

An example of a solution according to prior art is disclosed in prior art FIG. 1, showing a simplified cross-sectional side-view. A first surface-mounted waveguide part P1 and a second surface-mounted waveguide part P2 are mounted on a dielectric carrier material P3. The ends of these surface-mounted waveguide parts that face each other comprise respective 90° bends P4, P5, changing the direction of the transmitted signals 90° such that they are directed through corresponding openings P6, P7 in the dielectric carrier material P3. On the other side of the dielectric carrier material, a third surface-mounted waveguide part P8 is mounted, the third surface-mounted waveguide part comprising two 90° bends P9, P10 positioned such that the signal directed through the openings P6, P7 is guided through the third surface-mounted waveguide P8 part in such a way that it functions as a link between the first surface-mounted waveguide part P1 and the second surface-mounted waveguide part P2. The details of the bends P4, P5; P9, P10 are not shown in FIG. 1, only the function is schematically indicated.

This solution is, however, quite complicated and requires that a special waveguide part, having two 90° bends, is mounted on the other side of the dielectric carrier material, and that all waveguide parts are aligned with the openings such that there is no interruption in the transmission of the signals.

### SUMMARY

The object of the present invention is to provide a waveguide transition arrangement between different surface-mounted waveguide structure parts which are to be sufficiently electrically connected to each other in order to present a proper electrical function.

This problem is solved by means of a waveguide arrangement as mentioned initially. Said arrangement further comprises an electrically conducting sealing frame that is arranged to be mounted over the ends, covering them, where the frame has a first wall, a second wall and a third wall, where the second and third walls are arranged to contact a part of the metalization, all the walls together essentially forming a U-shape.

According to a preferred embodiment, there is a junction slot between the ends, where the sealing frame is arranged to seal the junction slot, such that the transition properties for a signal that is transferred between the mounted waveguide parts are enhanced.

According to another preferred embodiment, the waveguide parts each have a respective longitudinally extending flange part comprised in each of the second walls and third walls, and that the sealing frame has a respective longitudinally extending flange part, each having a length, the flange parts being comprised in each of the second wall and third wall, all the flange parts being arranged to be the parts of said walls which contact the corresponding parts of the metalization when the waveguide parts and the sealing frame are mounted.

According to another preferred embodiment, the flange parts of the waveguide parts do not extend to the to said ends of the waveguide parts, such that a first distance between the ends of opposing flange parts of the second walls of the waveguide parts and a second distance between the ends of opposing flange parts of the third walls of the waveguide parts both exceed the length of each one of the sealing frame's flanges, such that the sealing frame's flanges may be fitted between the respective flanges of the waveguide parts.

According to another preferred embodiment, the sealing frame is made in several layers of material; an outer layer being made of a polymer, a middle layer constituting a metalization layer, making the sealing frame electrically conductive, an inner layer comprising an electrically conducting attachment means in the form of a soft solder alloy or electrically conducting glue.

According to another preferred embodiment, in a part of the first waveguide part which is arranged to be covered by the sealing frame, a first recess is formed, running perpendicular to the longitudinal extension of the first waveguide part, all the way along the tree walls, where a corresponding second recess is formed on the second waveguide part, and where, corresponding to these recesses, lines of an electrically conducting attachment means are dispensed on the sides of the walls of the sealing frame that are intended to face the waveguide parts, such that the lines of electrically conducting attachment means are fitted into the recesses when the sealing frame is mounted.

According to another preferred embodiment, the first surface-mountable waveguide part, the second surface-mountable waveguide part and the sealing frame comprise at least one waveguide filter iris and at least one waveguide filter protruding part arranged for matching of a filter cavity, such that these parts constitute a waveguide filter when mounted together.

According to another preferred embodiment, the sealing frame comprises at least one protruding part on the side of a first wall, facing the dielectric carrier material when the sealing frame is mounted, and each surface-mountable waveguide part comprises at least one iris, such that a cavity structure is formed and the sealing frame at least partly forms the walls and roof of said cavity structure when the surface-mountable waveguide parts and the sealing frame are mounted.

According to another preferred embodiment, at least one sealing frame and at least two waveguide parts are combined such that a filter comprising at least two cavity structures is formed, the filter thus having at least two poles.

Other preferred embodiments are evident from the dependent claims.

A number of advantages are provided by the present invention. For example:
the sealing arrangement is simple and of low cost;
a connection of two surface-mounted waveguide parts is achieved without disturbance of the waveguide mode of a propagating signal;
two surface-mounted waveguide parts are connected in a loss-less manner;
two surface-mounted waveguide parts are connected in a flexible manner, providing a relaxed relation between the waveguide parts due to the ductile behaviour of the sealing frame;
two surface-mounted waveguide parts are connected without any risk of leakage;
the present invention can be assembled using a pick-and-place machine; and
two surface-mounted waveguide parts are connected using no extra area on the dielectric carrier material on which they are mounted.

### BRIEF DESCRIPTION OF THE DRAWINGS

The present invention will now be described more in detail with reference to the appended drawings, where:

FIG. 1 is a sectional side-view of a prior art configuration;

FIG. 2a is a top view of two surface-mounted waveguide parts;

FIG. 2b is a side view of two surface-mounted waveguide parts;

FIG. 2c is an end view of a surface-mountable waveguide part;

FIG. 3a is a top view of a sealing frame according to the present invention;

FIG. 3b is an end view of a sealing frame according to the present invention;

FIG. 4a is a side view of a sealing frame according to the present invention being mounted to two surface-mounted waveguide parts;

FIG. 4b is a sectional view of a section in FIG. 4a;

FIG. 5 is a detailed view of a part of the sealing frame, illustrating a preferred embodiment;

FIG. 6 is a perspective view of two surface-mountable waveguide parts and a sealing frame according to the present invention, positioned slightly apart from each other;

FIG. 7a is a top view of two surface-mounted waveguide filter parts;

FIG. 7b is an end view of a sealing frame arranged for a filter application;

FIG. 7c is a top view of the sealing frame according to FIG. 7b being mounted to the surface-mounted waveguide parts according to FIG. 7a;

FIG. 8 is a top view of a multiple filter arrangement according to the arrangement in FIG. 7c; and

FIG. 9 is a top view of an alternative to the arrangement sealing frame according to the arrangement in FIG. 7c.

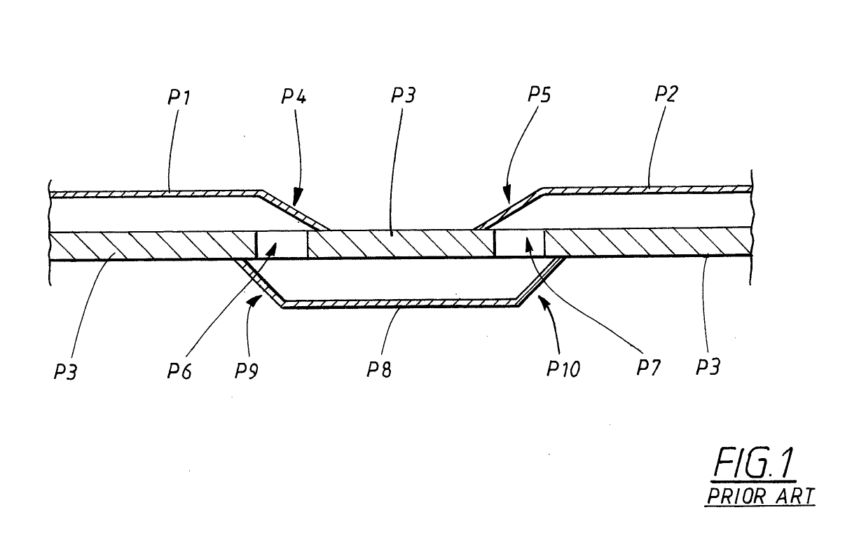

### DETAILED DESCRIPTION

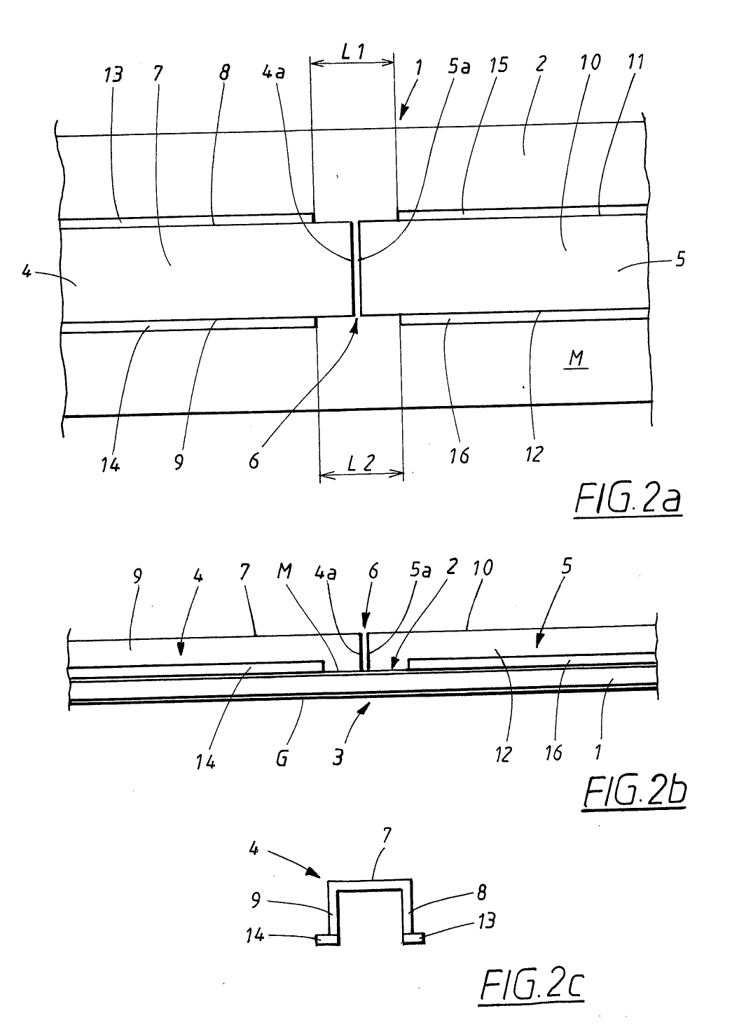

In FIG. 2a and FIG. 2b, showing a respective top view and side view of a first embodiment example of the present invention, a dielectric carrier material 1 is shown, having a first main side 2 and a second main side 3, originally having a metallic copper cladding on both sides. The copper cladding on the second main side 3 is used as a ground plane G, and the copper cladding on the first main side 2 is generally etched away to such an extent that desired copper patterns are formed on the first main side 2, constituting a metalization M. A first surface-mountable waveguide part 4 and a second surface-mountable waveguide part 5 are mounted on a part of the metalization M that is provided on the first main side 2. Those respective ends 4a, 5a of these surface-mounted waveguide parts that face each other are positioned relatively close to each other, preferably as close as possible, minimizing a junction slot 6 between the waveguide parts 4, 5.

Each waveguide part 4, 5 is made in an electrically conducting material and has three respective walls 7, 8 9; 10, 11, 12 and one open side, arranged to face the dielectric carrier material 1. A part of the metalization provided on the first main side 1 of the dielectric carrier material 1, serves as the remaining wall of the waveguide parts 4, 5, thus closing the waveguide part 4, 5 when mounted.

Regarding the first waveguide part 4, also with reference to FIG. 2c, a first wall 7 is arranged to be parallel to the dielectric carrier material 1 when the first waveguide part 4 is mounted, and then held at a distance from said material by means of a second wall 8 and third wall 9, which second and third walls 8, 9 are arranged to contact a part of the metalization M on the first main side 2 of the dielectric carrier material 1, all the walls 7, 8, 9 together essentially forming a U-shape when regarding the first waveguide part 4 from its short end. The second waveguide part 5 has the same configuration of its walls 10, 11, 12.

The waveguide parts 4, 5 are mounted in a known way, each having a longitudinally extending flange part 13, 14; 15, 16 comprised in each of the second walls 8, 11 and third walls 9, 12, the flanges 13, 14; 15, 16 being arranged to be the parts of these walls 8, 11; 9, 12 which contact a part of the metalization M on the first main side 2 of the dielectric carrier material 1 when the waveguide parts 4, 5 are mounted. The flanges 13, 14; 15, 16 are soldered, or glued by means of electrically conducting glue, to the parts of the metalization M on the first main side 2 of the dielectric carrier material 1 which generally is constituted by a corresponding so-called footprint of copper, which footprint thus is comprised in the metalization M on the first main side 2 of the dielectric carrier material 1. In this particular application, there may not be any need for a particular footprint, but some kind of guidance for the mounting of the surface-mountable waveguide parts is preferred.

As indicated above, there is, however, always a junction slot 6 between the waveguide parts 4, 5 when mounted. At the junction slot 6, the currents running between the waveguide parts 4, 5 experience a discontinuity, and there is possibly also undesired leakage at the junction slot 6.

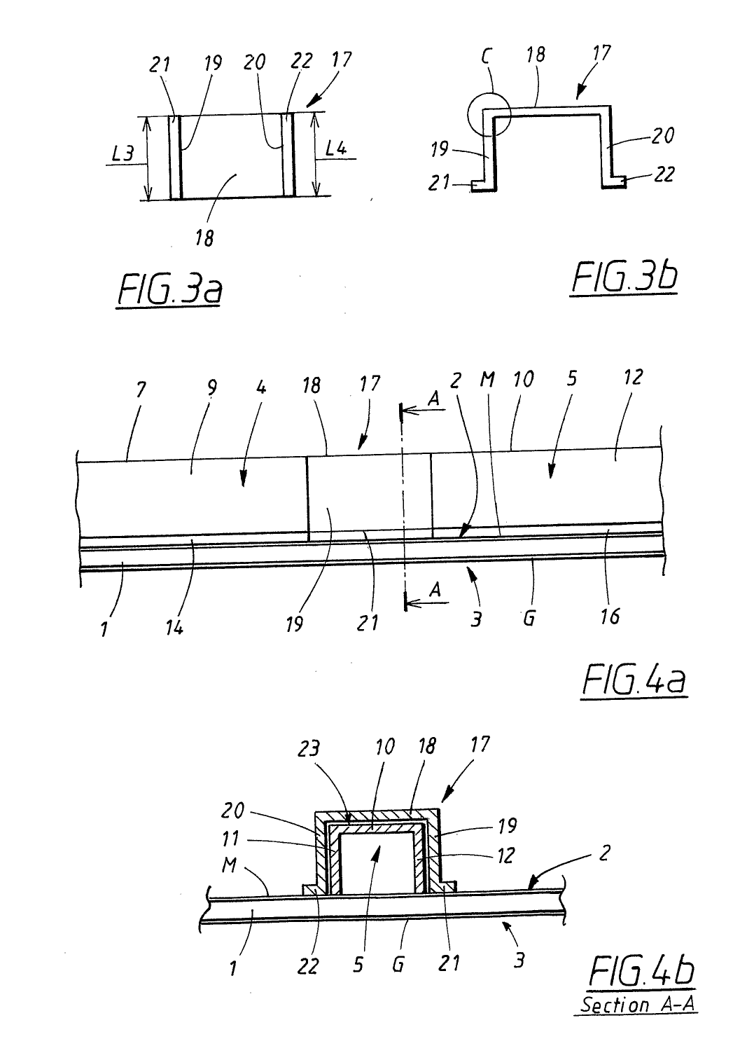

According to the present invention, with reference to FIG. 3a, FIG. 3b and FIG. 4a, an electrically conducting sealing frame 17 is arranged to be mounted over the junction slot 6. The sealing frame 17 has a first wall 18, a second wall 19 and a third wall 20, where the first wall 18 is arranged to be parallel to the dielectric carrier material 1 when it is mounted, and then held at a distance from said material 1 by means of the second wall 19 and the third wall 20, which second and third walls 19, 20 are arranged to contact a part of the metalization M on the first main side 2 of the dielectric carrier material 1, all the walls together essentially forming a U-shape when regarding the sealing frame 17 from its short end.

The sealing frame 17 has a respective longitudinally extending flange part 21, 22 comprised in each of the second wall 19 and third wall 20, each having a length L3, L4, the flanges 21, 22 being arranged to be the parts of these walls which contact the a part of the metalization M on the first main side 2 of the dielectric carrier material 1 when the sealing frame 17 is mounted. The length L3, L4 of the flanges 21, 22 is preferably essentially equal.

The sealing frame 17 has such dimensions that it is possible to fit it over the waveguide parts, i.e. the inner dimensions of the sealing frame 17 is equal to, or greater than, the outer dimensions of the waveguide parts 4, 5. The sealing frame's thickness is not of importance. However, it should preferably be rigid enough to be handled, for example by a human or by a pick-and-place machine.

As can be seen in FIG. 2a and FIG. 2b, the flanges 13, 14; 15, 16 of the waveguide parts 4, 5 do not extend to the ends 4a, 5a of the waveguide parts that face each other, such that a first distance L1 between the ends of opposing flanges 13, 15 of the second walls 8, 11 of the waveguide parts 4, 5 and a second distance L2 between the ends of opposing flanges 14, 16 of the third walls 9, 12 of the waveguide parts 4, 5 both exceed the length L3, L4 of each one of the sealing frame's flanges 21, 22, such that the sealing frame's flanges 21, 22 may be fitted between the respective flanges 14, 16; 13, 15 of the waveguide parts 4, 5. Preferably, the distances L1 and L2 between the ends of opposing flanges 14, 16; 13, 15 of the waveguide parts 4, 5 are positioned essentially opposite each other with reference to the waveguide parts' longitudinal extension.

With reference to FIG. 4a and FIG. 4b, when mounted, the sealing frame 17 is fitted over the junction slot 6 between the waveguide parts 4, 5, sealing it. The sealing frame 17 is then soldered to the waveguide parts 4, 5. It is also conceivable that electrically conducting glue is used. The solder or glue is indicated with the reference number 23. The sealing frame is also preferably soldered or glued to the part of the metalization M on the first main side 2 of the dielectric carrier material 1 that is in contact with the sealing frame's flanges 21, 22.

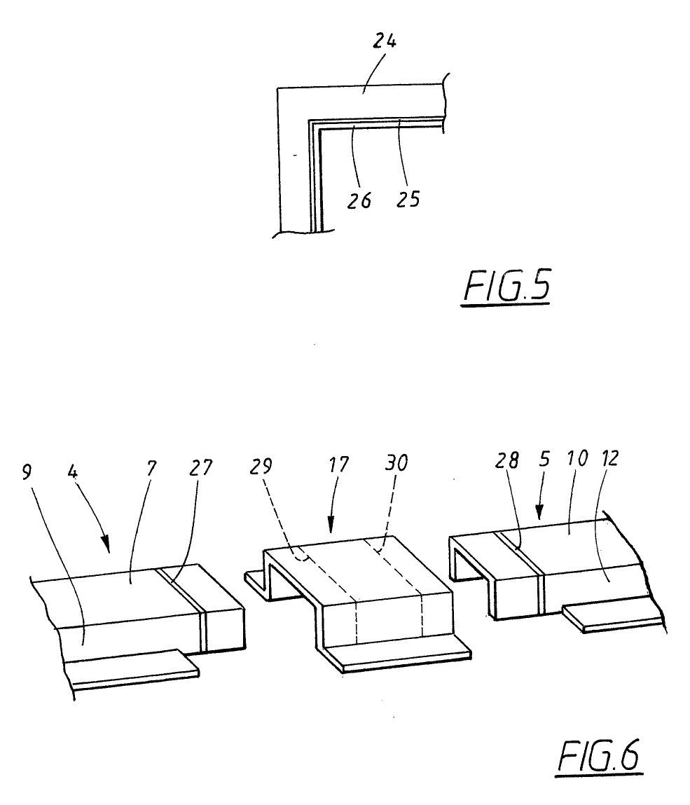

According to a preferred embodiment, with reference to FIG. 5, showing the part of the sealing frame 17 indicated by a circle C in FIG. 3b, the sealing frame 17 is made in several layers of material. For rigidity, the outer layer 24 is made of a ductile layer, for example a polymer. Inside the outer layer there is a metalization layer 25, making the sealing frame electrically conductive. The metalization layer 25 is in turn covered by a soft solder alloy 26 with an appropriate thickness, for example about 150 μm. The soft solder alloy 26 may be exchanged with any appropriate electrically conducting attachment means, such as electrically conducting glue.

According to another preferred embodiment, with reference to FIG. 6, showing a perspective view of the first waveguide part 4, the second waveguide part 5 and the sealing frame 17 positioned slightly apart from each other, at the part of the first waveguide part 4 which is arranged to be covered by the sealing frame 17, a first recess 27 is formed. The first recess 17 runs perpendicular to the longitudinal extension of the first waveguide part 4, all the way along the tree walls 7, 8, 9. A corresponding second recess 28 is formed on the second waveguide part 5.

Corresponding to these recesses 27, 28, lines 29, 30 of solder compound are dispensed on the sides of the walls 18, 19, 20 of the sealing frame 17 that are intended to face the waveguide parts, such that the lines of solder 29, 30 are fitted into the recesses 27, 28 when the sealing frame 17 is mounted. It is possible to combine the lines of solder 29, 30 with indents in the sealing frame 17, the indents being intended to fit into the recesses 27, 28 when the sealing frame 17 is mounted. The solder may be exchanged with any appropriate electrically conducting attachment means, such as electrically conducting glue.

According to a special embodiment of the present invention, a sealing frame may be used in a surface-mounted waveguide filter.

Surface-mounted waveguide filters are for example used in a diplexer structure, where the diplexer structure needs to support different frequency channels within a certain frequency band. In order to obtain these different frequency channels, each filter in the diplexer structure has to be calibrated by means of screws which are screwed into a filter wall. The screws form matching elements when they protrude the filter wall, entering cavity structures of the filter in a previously known way. By setting each screw at a certain protrusion, a calibrated filter is obtained, but finding the optimal level of protrusion is a time-consuming task.

Furthermore, as mentioned initially, it is necessary to split up the diplexer into a number of smaller parts.

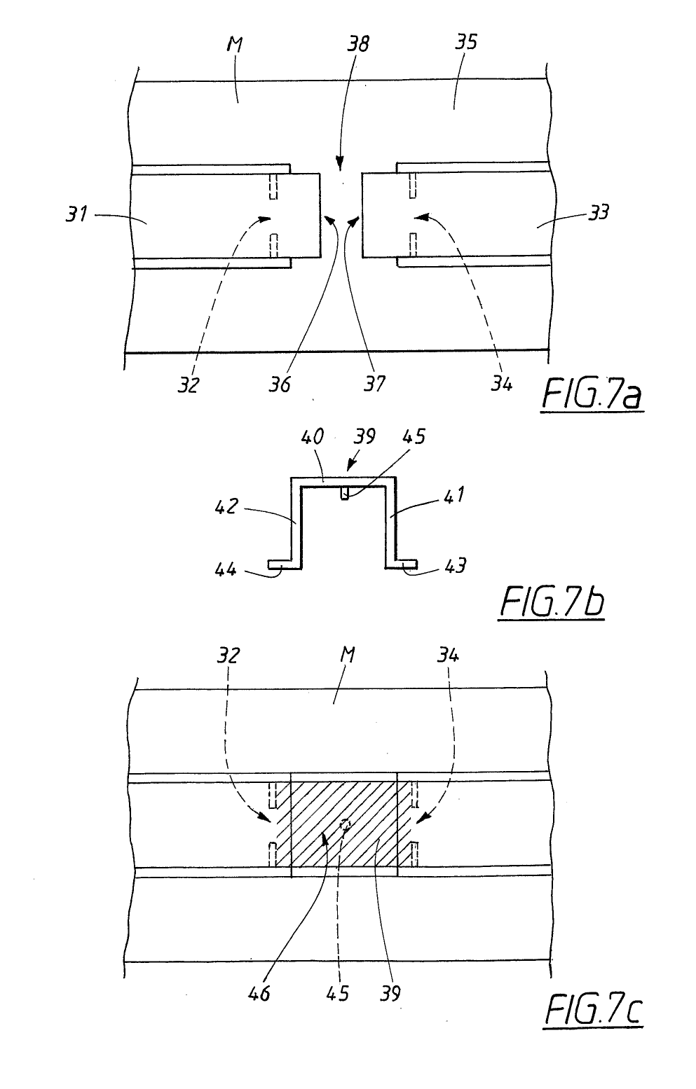

FIG. 7a shows a first surface-mountable waveguide part 31 comprising a first filter iris 32, and a second surface-mountable waveguide part 33 comprising a second filter iris 34. The first and second surface-mountable waveguide parts 31, 33 are mounted in the same manner as the previously described waveguide part, such that one opening 36 of the first waveguide part 31 faces an opening 37 of the second waveguide part 33.

There is a certain gap 38 between the waveguide parts 31, 33, and, with reference to FIG. 7b, an electrically conducting sealing frame 39 is arranged to be mounted over the gap 38. The sealing frame 39 is similar in appearance to the one described previously, having a first wall 40, a second wall 41 and a third wall 42, where the first wall 40 is arranged to be parallel to the dielectric carrier material 35 when the sealing frame 39 is mounted, and then held at a distance from said material 35 by means of the second wall 41 and the third wall 42, all the walls together essentially forming a U-shape when regarding the sealing frame 39 from its short end.

The sealing frame 39 has a respective longitudinally extending flange part 43, 44 comprised in each of the second wall 41 and third wall 42.

An important difference is that this sealing frame 39 comprises a protruding part 45 on the side of the first wall 40 that faces the dielectric carrier material 35 when the sealing frame 39 is mounted, being arranged to match the filter that is obtained, as shown in FIG. 7c. Between the pair of irises 32, 34, a cavity structure 46 is formed, indicated with diagonal lines in FIG. 7c, and the sealing frame 39 at least partly forms the walls and roof of said cavity structure. The protruding part 45 has the same task as the previously described screw; to match the properties of a cavity structure. The protruding part 45 has a specific size and is made of a certain material. The protruding part 45 can be made to confer the proper conditions for the cavity 46 to meet the desired channel frequency. It is of course necessary that the gap 38 is wide enough to permit the protruding part to enter into the cavity structure.

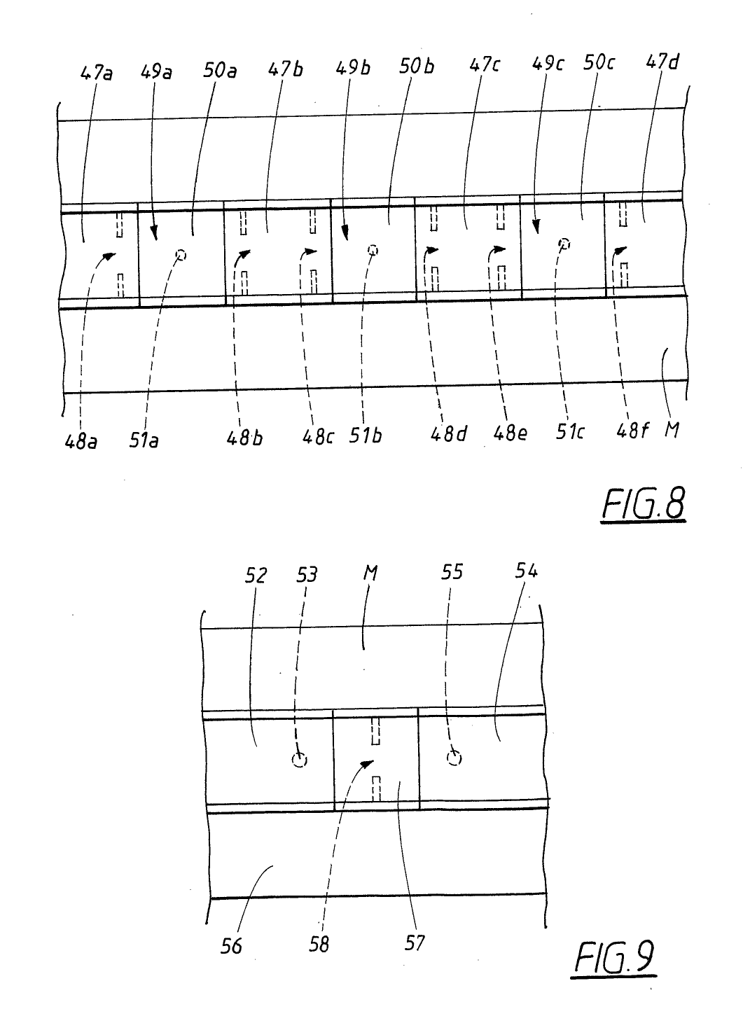

With reference to FIG. 8, it is of course possible to mount a number of waveguide parts 47a, 47b, 47c, 47d, comprising irises 48a, 48b, 48c, 48d, 48e, 48f, after each other, such that a number of cavity structures 49a, 49b, 49c are formed when corresponding sealing frames 50a, 50b, 50c with protruding parts 51a, 51b, 51c are mounted. For each cavity structure, a pole is added to the filter. Each waveguide part comprises at least one iris.

In this way, a high degree of freedom and versatility is acquired, since it is now possible to choose the correct parts from a number of prefabricated parts and mount them in such a way that a desired filter and diplexer is obtained. In other words, a modular building block technique may be used, offering a large number of combinations. The length of each cavity structure may be adjusted to a desired value just by mounting the waveguide parts with a certain gap between each other; if the sealing frame has a sufficient length, it will cover the gap, and the desired cavity structure may be obtained.

More than one protruding part may be used for each sealing frame, should it be desired. The protruding parts can have any appropriate form and be made in any appropriate material. If not necessary for a certain cavity, no protruding part is used.

In an alternative embodiment form, with reference to FIG. 9, a first surface-mountable waveguide part 52 comprises a first protruding part 53, and a second surface-mountable waveguide part 54 comprises a second protruding part 55. The surface-mountable waveguide parts 52, 54 are mounted on a metalization on a dielectric carrier material 56 and joined by means of a sealing frame 57 in the same manner as described previously. The sealing frame 57 is here equipped with an iris 58. Generally, in this way, the waveguide parts 52, 54 comprise protruding parts 53, 55, and the sealing frames 57 comprise irises 58. This configuration is of course applicable to all filter embodiments discussed above. A combination is also conceivable.

The gap 38 discussed in the filter embodiments above, corresponds to the junction slot described previously.

The shape and material of the protruding parts may be of any suitable form. The shape may for example be cylindrical or rectangular, and the material may for example be copper or a ferrite material.

The present invention is not limited to the embodiment examples according to the above, but may vary freely within the scope of the appended claims.

For example, the copper used on the first mains side 2 and the second main side 3 may be any suitable conducting material constituting a suitable metalization, for example silver or gold. The metal may be printed to the dielectric carrier material. There may also be several layers of metallic material, for example comprising solder.

The waveguide parts may also be made in a non-conducting material, such as plastic, which is covered by a thin layer of metalization.

The dielectric carrier material may comprise several layers if necessary, the layers comprising different types of circuitry. Such a layer structure may also be necessary for mechanical reasons.

The flanges may be of any suitable form, generally forming flange parts.

1. A transition arrangement comprising a first surface-mountable waveguide part (4), a second surface-mountable waveguide part (5) and a dielectric carrier material (1) with a metalization (M) provided on a first main side (2), the first waveguide part (4) comprising a first wall (7), a second wall (8) and a third wall (9), which second and third walls (8, 9) are arranged to contact a part of the metalization (M), all the walls (7, 8, 9) together essentially forming a U-shape, the second waveguide part (5) comprising a first wall (10), a second wall (11) and a third wall (12), which second and third walls (11, 12) are arranged to contact a part of the metalization (M), all the walls (10, 11, 12) together essentially forming a U-shape, where the surface-mountable waveguide parts (4, 5) are arranged to be mounted on the parts of the metalization (M) in such a way that the surface-mountable waveguide parts (4, 5) comprise ends (4a, 5a) which are positioned to face each other, characterized in that the transition arrangement further comprises an electrically conducting sealing frame (17) that is arranged to be mounted over the ends (4a, 5a), covering them, where the frame (17) has a first wall (18), a second wall (19) and a third wall (20), where the second and third walls (19, 20) are arranged to contact a part of the metalization (M), all the walls (18, 19, 20) together essentially forming a U-shape.

2. A transition arrangement according to claim 1, characterized in that there is a junction slot (6) between the ends (4a, 5a), where the sealing frame (17) is arranged to seal the junction slot (6), such that the transition properties for a signal that is transferred between the mounted waveguide parts (4, 5) are enhanced.

3. A transition arrangement according to claim 1, characterized in that the waveguide parts (4, 5) each have a respective longitudinally extending flange part (13, 14; 15, 16) comprised in each of the second walls (8, 11) and third walls (9, 12), and that the sealing frame (17) has a respective longitudinally extending flange part (21, 22), each having a length (L3, L4), the flange parts (21, 22) being comprised in each of the second wall (19) and third wall (20), all the flange parts (13, 14; 15, 16; 21, 22) being arranged to be the parts of said walls (8, 11; 9, 12; 19, 20) which contact the corresponding parts of the metalization (M) when the waveguide parts (4, 5) and the sealing frame (17) are mounted.

4. A transition arrangement according to claim 3, characterized in that the flange parts (13, 14; 15, 16) of the surface-mountable waveguide parts (4, 5) do not extend to the to said ends (4a, 5a) of the surface-mountable waveguide parts (4, 5), such that a first distance (L1) between the ends of opposing flange parts (13, 15) of the second walls (8, 11) of the surface-mountable waveguide parts (4, 5) and a second distance (L2) between the ends of opposing flange parts (14, 16) of the third walls (9, 12) of the surface-mountable waveguide parts (4, 5) both exceed the length (L3, L4) of each one of the sealing frame's flanges (21, 22), such that the sealing frame's flanges (21, 22) may be fitted between the respective flanges (14, 16; 13, 15) of the surface-mountable waveguide parts (4, 5).

5. A transition arrangement according to claim 4, characterized in that the first distance (L1) and the second distance (L2) are essentially equal, and that the lengths (L3, L4) of the sealing frame's flanges (21, 22) are essentially equal.

6. A transition arrangement according to claim 1, characterized in that the sealing frame (17) is attached to the surface-mountable waveguide parts (4, 5) by means of solder or electrically conducting glue.

7. A transition arrangement according to claim 1, characterized in that the sealing frame (17) is made in several layers of material; an outer layer (24) being made of a polymer, a middle layer constituting a metalization layer (25), making the sealing frame electrically conductive, an inner layer comprising an electrically conducting attachment means in the form of a soft solder alloy (26) or electrically conducting glue.

8. A transition arrangement according to claim 1, characterized in that a part of the first surface-mountable waveguide part (4) which is arranged to be covered by the sealing frame (17), a first recess (27) is formed, running perpendicular to the longitudinal extension of the first surface-mountable waveguide part (4), all the way along the tree walls (7, 8, 9), where a corresponding second recess (28) is formed on the second surface-mountable waveguide part (5), and where, corresponding to these recesses (27, 28), lines (29, 30) of an electrically conducting attachment means are dispensed on the sides of the walls (18, 19, 20) of the sealing frame (17) that are intended to face the surface-mountable waveguide parts (4, 5), such that the lines (29, 30) of electrically conducting attachment means are fitted into the recesses (27, 28) when the sealing frame (17) is mounted.

9. A transition arrangement according to claim 8, characterized in that the lines (29, 30) are combined with indents in the sealing frame (17), the indents being intended to fit into the recesses (27, 28) when the sealing frame (17) is mounted.

10. A transition arrangement according to claim 8, characterized in that the electrically conducting attachment means is in the form of solder or electrically conducting glue.

11. A transition arrangement according to claim 1, characterized in that the first surface-mountable waveguide part (31), the second surface-mountable waveguide part (33) and the sealing frame (39) comprise at least one waveguide filter iris (32, 34) and at least one waveguide filter protruding part (45) arranged for matching of a filter cavity (46), such that these parts constitute a waveguide filter when mounted together.

12. A transition arrangement according to claim 11, characterized in that the sealing frame (39) comprises at least one protruding part (45) on the side of a first wall (40), facing the dielectric carrier material (35) when the sealing frame (39) is mounted, and in that each surface-mountable waveguide part (31, 33) comprises at least one iris (32, 34), such that a cavity structure (46) is formed and the sealing frame (39) at least partly forms the walls and roof of said cavity structure when the surface-mountable waveguide parts (31, 33) and the sealing frame (39) are mounted.

13. A transition arrangement according to claim 12, characterized in that when the surface-mountable waveguide parts (31, 33) and the sealing frame (39) are mounted, the protruding part (45) protrudes between the first surface-mountable waveguide part (31) and the second surface-mountable waveguide part (33), and enters into the cavity structure (46).

14. A transition arrangement according to claim 11, characterized in that the sealing frame (57) comprises at least one iris (58), and in that each surface-mountable waveguide part (52, 54) comprises at least one protruding part (53, 55).

15. A transition arrangement according to claim 11, characterized in that at least one sealing frame (50a, 50b, 50c; 57) and at least two waveguide parts (47a, 47b, 47c, 47d; 52, 54) are combined such that a filter comprising at least two cavity structures (49a, 49b, 49c) are formed, the filter thus having at least two poles.
